(19) United States
(12) Patent Application Publication
(10) Pub. No.: US 2001/0032730 A1
(43) Pub. Date: Oct. 25, 2001

(54) Metallic optical aerial cable

(76) Inventor: Carsten M. Gregor, Oberhausen (DE)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/781,942

(22) Filed: Feb. 14, 2001

(30) Foreign Application Priority Data
Feb. 15, 2000 (DE) 10006806.5

(51) Int. Cl. H01B 7/18

(52) U.S. Cl. 174/102 R

(57) ABSTRACT

A metallic optical aerial cable comprising a metal tube (2), which has a longitudinal weld seam and contains one or more optical waveguides, and a metal wire (1) which is connected to the metal tube (2) in force- or shape-locking fashion.

### DESCRIPTION

The invention relates to a metallic optical aerial cable.

Due to the superiority of optical cables compared to conventional copper cables in terms of transmission rate and transmission quality, it has long been endeavoured to further expand the optical waveguide infrastructure for access-, distribution- (local-, regional-) and long-distance connections.

For the development of the optical waveguide cable network, the cables are laid in accordance with conventional technology by digging up roads, pavements etc. and in so-called cable ducts. These types of installation are highly time-consuming and costly. Furthermore the provided cable lines are often already fully occupied. Often it is no longer possible to install further cables as access to the existing cables would be impeded or even prevented. Therefore different forms of installation are always being sought after. Thus it is known to install optical cables in existing supply- and disposal lines in order also to be able to avoid possibly occurring right-of-way problems.

It is also known to install so-called aerial cables in order to reduce installation costs. Aerial cables are used in particular for long-distance power supply purposes.

Recently the earthing conductors or also the phase conductors of overhead installations have also been used for the transmission of information.

Thus for example it is known to replace one of the wires of earthing conductors or phase conductors by a metallic tube containing a plurality of optical waveguides. Also known are aerial cables for long-distance purposes consisting of a metallic core having grooves which extend in its surface, optical waveguides or optical waveguide elements being inserted in said grooves. The grooves are closed by tape lapping. As tension elements, a plurality of metal wires are stranded onto the core provided with the tape lapping. However, because of various disadvantages aerial cables are now hardly used in access- (local- and regional) networks and distribution networks for supplying subscribers.

The object of the present invention is to make available an aerial cable which can be produced and installed in such a cost-efficient manner that it can be used in the distribution and access sectors of an optical transmission network and at the same time has a long service life and high level of reliability.

This object is achieved by the disclosure of claim 1.

Further advantageous developments of the invention are described in the sub-claims.

In addition to the advantage directly resultant from the object of the invention, the cable according to the invention also has the advantage that on account of its small dimensions it can be installed unobtrusively. It can be produced in long lengths and can be transported either wound into rings or on a conventional cable drum to the end consumer, where it can be removed from the ring or drum in the required length.

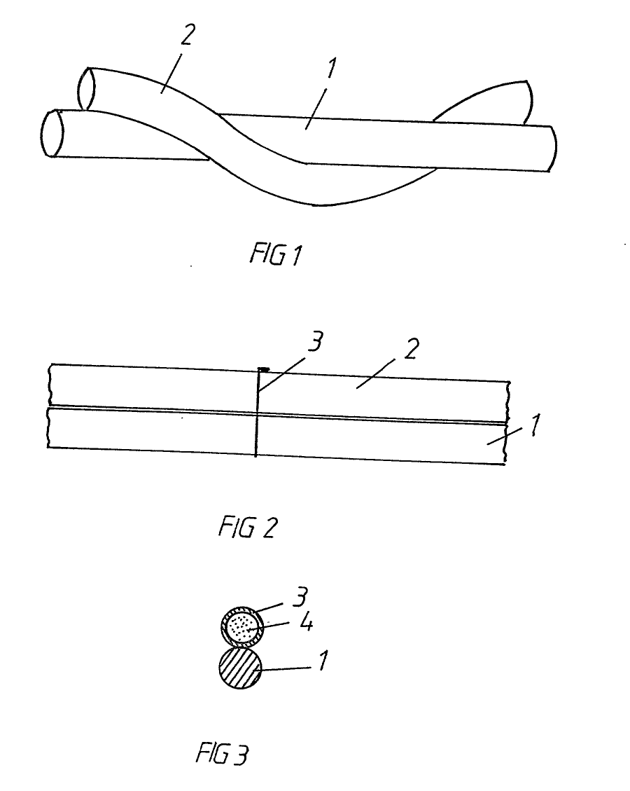

The invention is explained in detail in the form of the exemplary embodiment schematically illustrated in FIGS. 1 to 3.

In FIG. 1, the reference numeral 1 designates a metal wire which extends in a substantially straight fashion in the direction of its longitudinal axis and about which a metal tube 2 is stranded. The metal tube 2 is produced by shaping a metal strip to form an open-seam tube and welding the edges of the open-seam tube. A production process for a metal tube of this kind is described in DE-A-44 34 133.

Before the open-seam tube is closed, one or more optical waveguides are inserted into the open-seam tube, optionally together with a viscous mass. Using the described process, metal tubes of this type can be produced in one piece in lengths exceeding 6 km.

The metal tube 2 contains a plurality of optical waveguides.

FIG. 2 is a lateral view of another embodiment of an aerial cable according to the theory of the invention.

The metal wire 1 and the metal tube 2 containing the optical waveguides in its interior extend in parallel to one another and are connected to one another at specified intervals of approximately 1000 mm, for example by spot welding or by a binding wire 3, preference being given to the connection by means of the wire 3.

FIG. 3 is a section through an aerial cable as shown in FIGS. 1 or 2. The optical waveguides arranged in the metal tube 2 are referenced 4.

In the case of the illustrated aerial cables the diameter of the wire 1 amounts to approximately 3.5 mm and the outer diameter of the metal tube 2 likewise amounts to 3.5 mm. The wall thickness of the metal tube 2 amounts to approximately 0.25 mm. Up to thirty six optical waveguides 4 can be accommodated in a metal tube 2 of this kind.

Particularly advantageously, the metal wire 1 is a steel wire provided with a zinc coating to protect the steel wire from corrosion. The zinc coating advantageously contains a few weight % aluminium which further increases the corrosion resistance of the metal wire 1. Coated steel wires of this kind are commercially available under the trade name Carpal wires. In a modification of the principle of the invention, the metal wire 1 can also consist of a steel wire with a coating of stainless steel or aluminium or can be produced entirely from high-grade steel.

The metal tube 2 preferably consists of stainless steel, although it is also possible to use normal steel with a high tensile strength, in which case the metal tube 2 must then be provided with an anti-corrosive coating which for example can consist of stainless steel or a zinc coating. Upon installation the aerial cable, comprising the metal wire 1 and the metal tube 2 connected to the metal wire 1, is unwound from the supply ring or cable drum and cut to the required length.

The metal wire 1 is attached for example by a so-called clamping coil to the end points, e.g. to walls of buildings, masts, trees.

The metal tube 2, and thus the optical waveguides 4 extending therein, are consequently free of mechanical stresses.

1. A metallic optical aerial cable comprising a metal tube, which has a longitudinal weld seam and contains one or more optical waveguides, and a metal wire connected to the metal tube in force- or shape-locking fashion.

2. An aerial cable according to claim 1, characterised in that the metal tube and the metal wire are interstranded with one another.

3. An aerial cable according to claim 1, characterised in that the metal tube is stranded around the straight metal wire.

4. An aerial cable according to claim 1, characterised in that the metal tube and the metal wire are arranged extending in parallel to one another and are connected to one another in shape- or force-locking fashion at intervals along their longitudinal axis.

5. An aerial cable according to claim 4, characterised in that the metal tube and the metal wire are connected by thin metal-binding wires.

6. An aerial cable according to claim 1 or one of the following claims, characterised in that the metal wire is twisted about its longitudinal axis.

7. An aerial cable according to claim 1 or one of the following claims, characterised in that the metal tube and the metal wire are welded to one another at least in sections.

8. An aerial cable according to claim 1, characterised in that the metal tube consists of steel, preferably stainless steel.

9. An aerial cable according to claim 1 or one of the following claims, characterised in that the metal tube has a tape lapping composed of metal or a polymer material.

10. An aerial cable according to claim 1 or one of the following claims, characterised in that the metal wire is a zinc-coated steel wire.

11. An aerial cable according to claim 10, characterised in that the zinc coating of the steel wire contains aluminium.

12. An aerial cable according to claim 1 or one of the following claims, characterised in that the metal wire has a stainless steel coating.

13. An aerial cable according to claim 1 or one of the following claims, characterised in that the metal wire (1) consists of stainless steel.

14. An aerial cable according to claim 1, characterised in that the metal tube (2) has a corrugation.
